(19) United States
(12) Patent Application Publication
(10) Pub. No.: US 2004/0236840 A1
(43) Pub. Date: Nov. 25, 2004

(54) Method and apparatus for operating a primary PC from a remote pseudo-mobile PC

(76) Inventor: Amit Sarkar, Scarsdale, NY (US)

Correspondence Address: Eli Weiss, Esq., GREENBERG TRAURIG, LLP, 885 Third Avenue, New York, NY, 10022, US

(21) Appl. No.: 10/715,090

(22) Filed: Nov. 17, 2003

Related U.S. Application Data
(60) Provisional application No. 60/452,330, filed on Mar. 6, 2003.

(51) Int. Cl. G06F 15/16

(52) U.S. Cl. 709/208

(57) ABSTRACT

This invention allows a user to access and use the software in his/her primary PC from remotely located “dumb” peripheral hardware which can comprise a monitor, keyboard, mouse, and a modem. The only function of the peripheral hardware is to send information signals to the remotely located primary PC where they are processed and transmitted back to the peripheral hardware for display and use by the user. The information signals sent from the peripheral hardware to the remotely located primary PC can be in the form of raw, unprocessed signals. The peripheral hardware uses the computing power of the primary PC; the CPU, applications, files and services of the primary PC to process the raw signals. Therefore, as the peripheral hardware needs only very limited power, it does not require its own software and associated hardware to duplicate such processing functions.

### CROSS REFERENCE TO RELATED APPLICATIONS

This application claims the benefit of U.S. provisional application No. 60/452,330, filed on Mar. 6, 2003.

### BACKGROUND OF THE INVENTION

1. Field

The present invention relates generally to computer networking, and more particularly to a new method and apparatus for transmitting information (input) signals from a mobile device to a users primary PC such as a desktop PC for processing and then transmitting the processed information (output) signals from the primary PC back to the mobile device, thus enabling the user to operate the primary PC remotely from the mobile device.

2. Description of the Related Art

Local area networks (LANs) normally consist of nodes interconnected by physical telecommunications channels such as coaxial cable, twisted pair wire or fiber optics. Currently wireless LANs, the nodes of which are not connected by means of a physical channel, are being more widely used. Communication between these wireless LANs are normally by infrared (IR) or radio waves. A primary benefit of using wireless LANs is that a physical connection, i.e., cabling, is not required. This is particularly useful for mobile nodes such as laptop and notebook computers, PDAs (Personal Digital Assistant) and the like. If appropriately equipped with a suitable wireless adapter which includes a transmitter, receiver and a modem, mobile nodes can move around and still remain connected to the network, provided the nodes do not move out of range of a wireless radio tower.

Normally, to establish a connection between a notebook PC, a desk top PC and a LAN, a router can be used. The Network Operating System (NOS) of the desktop PC is provided with a built in router program connected to the Network Operating System on the LAN. Data in the form of information packets from the NOS of the notebook PC destined for either the NOS of the desktop PC or the NOSs on the LAN is first received by the router program on the NOS of the desktop PC. Based on the destination information contained in the data packet, the router will either send the data packet to the NOS of the desktop PC or to NOSs on the LAN.

Another method of establishing a connection between a notebook PC, a desk top PC and a LAN is with the use of a three way bridge. With this method, the NOS of the desktop PC is directly connected to the three way bridge program on the desktop PC. The NOS of the notebook PC is connected directly to the same three way bridge program. The NOSs on the LAN are also connected directly to the same three way bridge program.

The main difference between the router and the three way bridge is that the router redirects data in the OSI (Open System Interconnection Standard) layer 3, i.e., the network layer; and the three way bridge redirects data in the OSI layer 2, i.e., the data link layer.

In those instances where there is only one notebook PC, one desktop PC and a LAN, the three way bridge is simple to set up and use.

At the present time a powerful laptop computer with an Internet connection through an Internet Service Provider (ISP) approaches true mobile computing. However, in the U.S., the absence of a broadband wireless network has severely limited mobile computing functionality and, therefore, consumer acceptance. Some of the negative factors associated with mobile computing are the physical bulk of the laptop PC; extremely short battery life; and, very high capital and operating cost which, for a laptop, is typically double that of a desktop PC with similar power, features and functionality for hardware alone.

The laptop PC used today is separate from and different than the desk top computer located in the office or home that a user has become dependent upon, and usually considered by the user to be his/her Primary PC. Typically, each user increasingly customizes his/her desktop PC with software and hardware adapted to perform specific desired functions. Therefore, when a user has a desktop PC, or any PC which the user considers to be his/her primary PC and a mobile laptop type of PC, any and all applications, functions, files and folders that are in the primary (desktop) PC is normally duplicated in the mobile laptop type of PC. Obviously, this duplication of applications and functions requires the user to again pay for all licensed software in use, ISP service, hardware, software, files (essentially the entire hard disc), network access, virus protection, firewall access (if applicable) and so on, to configure the laptop to be a perfect and complete substitute for the primary PC. In addition, practically any usage of the mobile laptop PC must normally be manually duplicated in the primary PC or, vice versa, if the laptop type of PC is to be a substitute for the primary (desktop) PC.

Other currently available devices that are less expensive than a laptop PC and are used to provide, in varying degrees, mobile computing services are, for example, advanced cellular phones, Palm Pilot, Window CE based devices and Blackberry. These devices have been generally accepted and have found wide use, but they are all plagued with one or more of the following disadvantages;

A. Extremely limited functionality; e.g., practically the only functionality Blackberry provides is e-mail capability;

B. Extremely limited data transfer capability; e.g., a cellphone is not a dataphone; it is primarily a voice device capable of transmitting and receiving very limited data (text, graphics);

C. Limited range; some devices work only within a very short distance. In some devices, the limitation of range is comparable to the distance over which a cellphone can transmit relative to the distance that a cordless phone can transmit;

D. Unsupported by a robust national network; e.g., Wi-Fi provides expensive broadband internet connection only at a handful of locations;

E. Inoperability and lack of interchangeability; none of these devices generally work with each other and/or with a desktop PC seamlessly;

F. Inflexibility; most of the devices require slavery to proprietary software and hardware; consumers are forced to frequently pay for “upgrades” that improve performance very little;

G. High cost; the cost is relatively high regardless of how severely limited the functionality or availability may be; and,

H. Relatively short battery life which requires frequent and inconvenient recharging; dramatic improvement in battery life is unlikely if heavy “processing” continues to be performed at the mobile device itself.

None of the presently available mobile devices can be used as a complete, fully functional substitute for a primary or desktop PC which has permanently stored on its hard disk all of the users files and software. Clearly, what is needed is method and apparatus which allows a user to operate remotely his/her own primary or desktop computer at home or office from a mobile, hand held, lightweight (“dumb”) terminal which can include a monitor, keyboard and mouse.

### SUMMARY OF THE INVENTION

The present invention relates to mobile peripheral hardware such as a monitor, keyboard and mouse coupled to a remotely located primary PC such as a desktop PC in two way data communication over any existing network, such as a cellular network, a wireless LAN network, a Wi-Fi connection, and global networks, such as the public switched telephone network and/or the Internet Cloud. The remotely located primary or desktop PC is coupled to process all information received from the peripheral hardware and transmit the processed information back to the peripheral hardware for display and use by the user. This invention allows a user to use his/her primary (desktop) PC from a remote location from a mobile device containing a monitor, keyboard, mouse, and a modem. The only function of the mobile device hardware is to send input signals to the remotely located primary (desktop) PC where they are processed and transmitted back to the mobile device for display and use by the user. The peripheral hardware of the mobile device uses the computing power of the primary (desktop) PC; the CPU, applications, files and services of the primary (desktop) PC to process the raw signals and, therefore, it needs only very limited power. Additionally, it does not require its own hardware or software to duplicate these functions. If a monitor having a touch sensitive screen is used to transmit information, depending on the function chosen, the use of a keyboard may not always be necessary. For example, the keyboard may not be necessary in those instances where the user is accessing a collection of files of songs for use with a small MP3 player. The invention disclosed relates to method and apparatus for providing real mobile computing from a remote hand held, light weight “dumb” terminal. The hand held terminal is neither a small PC nor can it process input signals. Rather it simply transmits them to a remote primary (desktop) PC to be processed and receives the output signal for display.

Almost all PC users have customized their primary (desktop) computer to have on their hard disk all the information and software they need to satisfy their computing needs. The invention here disclosed is a small, light weight, inexpensive, hand held dumb terminal which provides true mobile computing by remotely accessing the users primary PC itself to do all the processing of desired information without physically being there.

The foregoing has outlined, rather broadly, a preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed concept and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more filly apparent from the following detailed description, the appended claim, and the accompanying drawings in which similar elements are given similar reference numerals.

FIGS. 1 and 2, when positioned with FIG. 1 located above FIG. 2, is a block diagram of a method in accordance with the principles of the present invention;

FIG. 3 is a schematic of a mobile device having access to a desk top PC according to the present invention; and,

FIG. 4 is another schematic of a mobile device having access to a desktop PC according to the present invention.

### DETAILED DESCRIPTION

The present invention provides method and apparatus for using mobile peripheral hardware such as a mobile dumb terminal, hereinafter referred to as a Pseudo-mobile PC, to access a primary PC such as a desk top PC. The Pseudo-mobile PC can have a monitor with a touch sensitive screen, a keyboard and a built in modem to send raw information signals to a primary PC such as a desk top PC for processing; and to receive the processed signals from the primary PC (desktop PC) for display by the Pseudo-mobile PC for use by the user of the Pseudo-mobile PC.

It is to be understood that the term “Primary PC” includes any PC, whether desktop or laptop or mobile which the user considers to be his/her main PC which has the software that the user is currently relying on to process the signals being transmitted by the Pseudo-mobile PC. The pseudo-mobile PC and primary PC can be connected to each other via an existing fixed line and/or wireless global communication network such as the Public Switched Telephone Network (PSTN) and the Internet “Cloud” (a global network of interconnected servers) in a secured manner.

The Pseudo-mobile PC can be a light weight handheld device which is much lighter than a laptop or tabletop PC, which consists of a high performance audio-video monitor, a compact relatively thin keyboard and a mouse with the capability of being attached to other devices such as, for example, a printer, a fax machine, MP3 player, etc. The Pseudo-mobile PC can be designed to have limited, specialized computing power. It is not, however, a PC. Rather it can be considered to be similar to a sophisticated cellular handset that functions as the “dumb” terminal of a primary PC and duplicates exactly what the user would see on the monitor of the primary PC. The only function of the pseudo-mobile PC is to provide wireless two way data communications between itself and the desktop PC and can include other digital data transmission protocol and standards besides PSTN/cellular protocol, such as Wi-Fi.

The modem used in the Pseudo-mobile PC allows two way communication between the primary PC and the pseudo-mobile PC to transfer digital signals from a primary PC to a pseudo-mobile PC and vice versa, in a totally secure mode. The hardware within the pseudo-mobile PC is adapted to run four layers of complementary software where:

Layer 1 is a translation layer between the pseudo-mobile PC user interface) input signals) and the underlying operating system;

Layer 2 digitizes and compresses the signals for wireless transmission;

Layer 3 converts and compresses signals and graphics into cellular transmission packets for PSTN network (or another network such as Wi-Fi; and

Layer 4 transmits the cellular packets over an existing cellular data transmission network through the router.

The functions for transmitting data from the primary PC to the Pseudo-mobile PC are the reverse of the functions for transmitting data from the Pseudo-mobile PC to the primary PC. Thus, functionally, during transmission to the desktop PC, the Pseudo-mobile PC will transmit input signals themselves (key board operation, mouse click, etc.) through the modem to the PC, and, during transmission from the primary PC, the Pseudo-mobile PC will receive the output signals themselves (multimedia and other output signals) from the primary PC through the modem for display on the screen of the Pseudo-mobile PC.

For the transmission of information through a cellular/PSTN network, the signal packets should be highly compressed using the most recent, but proven compression technology to enhance the performance within the limited cellular data transmission bandwidth available today.

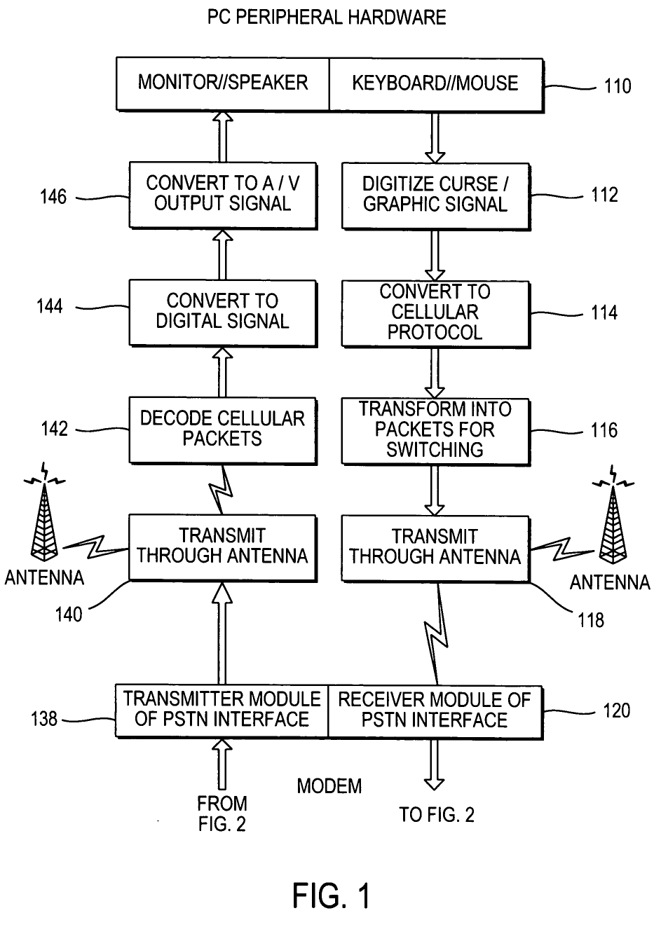

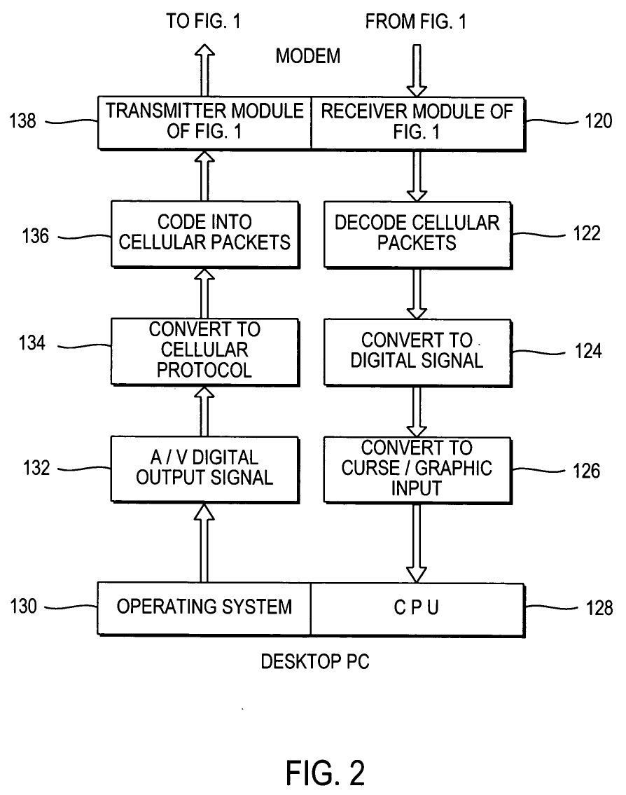

Referring to FIGS. 1 and 2, a user inputs information into the system via the keyboard and/or mouse of a Pseudo-mobile PC, step 1, block 110. At step 2, block 112, the information is digitized and then, at step 3, block 114, it is converted to cellular protocol. At step 4, block 116, the information in cellular protocol format is transformed into packets and are transmitted via radio waves, step 5, block 118 (and antenna), to receiver module, step 6, block 120. Referring now to FIG. 2, from step 6, block 120, the signal is fed to block 122, step 7 where the received packets are decoded, and then, at step 8, block 124, where they are converted to digital signals. At step 9, block 126, the digital signals are converted to curser/graphic signals and fed to the Central Processor Unit 128 of the primary PC for processing via the operating system 130 of primary PC.

Thus, at this time, the information that was remotely entered into the Pseudo-mobile PC and transmitted to the primary PC were processed the same as if it were entered directly into the primary PC. No processing was done by the Pseudo-mobile PC.

The information processed by the primary PC is now transmitted back to the Pseudo-mobile PC for viewing by the Pseudo-mobile PC user. At step 10, block 132, the information processed by the primary PC is converted into an audio/digital (A/V) signal, and then, at step 11, block 134, the A/V digital signals are converted to cellular protocol. At step 12, block 136, the cellular protocol signals are formatted into packets and forward to the transmit module, step 13, block 138, for transmission, via radio waves, step 14, block 140 (and antenna), for receipt by the Pseudo-mobile PC, step 15, block 142, which decodes the cellular packets. At step 16, block 144, the decoded cellular packets are converted to digital signals which are then converted to Audio/Video (AN) signals at step 17, block 146. Thereafter, the AN signals are fed to monitor/speaker of the Pseudo-mobile PC for viewing/listening by the user of the remote Pseudo-mobile PC at a remote location.

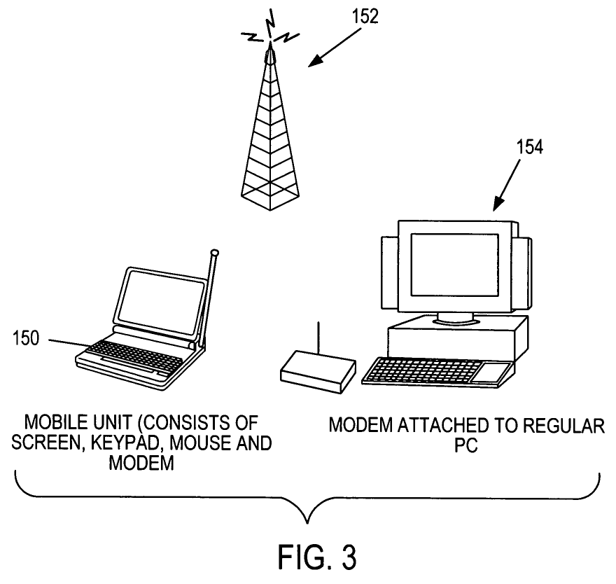

Referring to FIG. 3, there is shown a schematic of an arrangement for providing a Pseudo-mobile PC 150, consisting of a monitor, a keyboard and a mouse and having a modem for accessing, via radio waves, a desktop PC, 154, connected to an existing fixed line/wireless global communication network and having a modem for accessing the Pseudo-mobile PC 150.

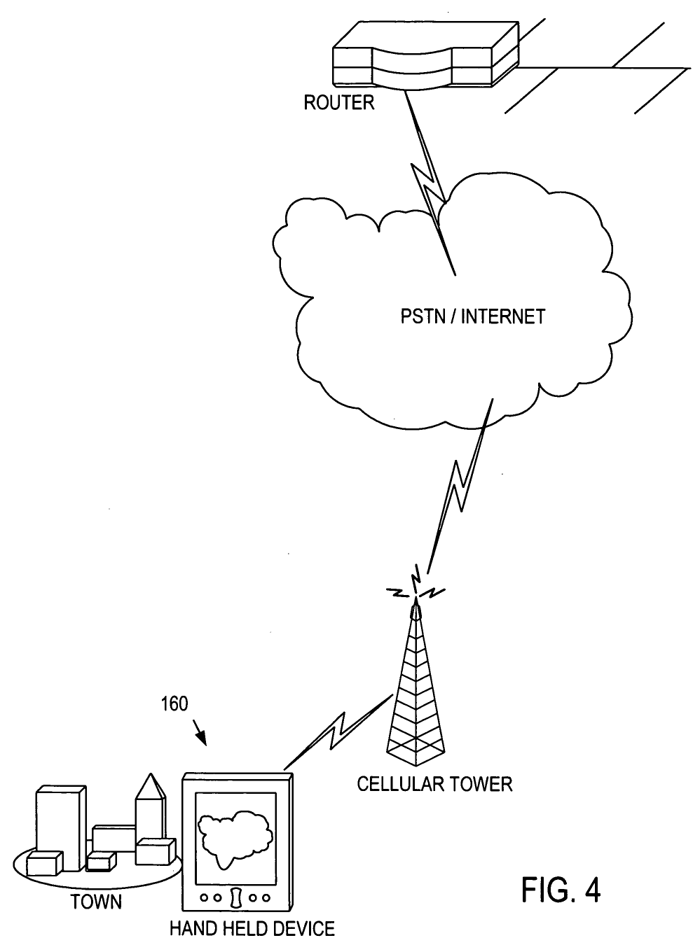

Referring to FIG. 4, there is shown a schematic of a small light weight handheld Pseudo-mobile device 160 which can consist of a monitor, a keyboard and a mouse together with a modem for communicating with a primary PC via the global PSTN/Internet Cloud. In the embodiment where the monitor of the Pseudo-mobile PC has a touch sensitive screen, then the Pseudo-mobile PC may not need detachable keyboard.

It is to be understood that in each embodiment shown above, the Pseudo-mobile PC can function with a monitor having a touch screen where the screen displays a menu of options and a stylus is used to select at least one of the displayed options. With this embodiment, and depending on the applications that are desired by a user, the keyboard and mouse may not be needed to practice the invention.

In the invention here disclosed, the user of a PC sees only the monitor of the Pseudo-mobile PC and operates on the key board and mouse, or on a touch sensitive screen of the monitor using either a stylus or his/her finger. Therefore, as the user is interested only in viewing the monitor and using the keyboard and the mouse (or touch sensitive screen of the monitor), then only this duplicate peripheral hardware (the Pseudo-mobile PC) needs to be remotely connected via a modem to a desktop PC. The Pseudo-mobile PC only needs access the primary PC and operate on its CPU because it is the primary PC which has huge processing power, storage capacity and hard disk containing all the software applications and files, and is supported by a fixed line/wireless global communications network for performing all of the various computing functions required by the user located remotely with his/her Pseudo-mobile PC. Thus, with this invention, by using a monitor, keyboard and mouse contained in the Pseudo-mobile PC, the user can access and use his/her own primary PC (office or home desktop PC) from a remote location without requiring the use of a separate PC or any other device or hardware, or have to pay for software application licenses (e.g., MS-Office), operating systems (e.g., Windows) or services such as broadband ISP service for internet. The only cost to a user will be the data communication charges for actual use of the cellular network for the transmission of input and output signals.

In operation, “raw” input/output signals of the Pseudo-mobile PC are transmitted to and from the primary PC. The input signals to the primary PC are processed by the primary PC and are than extracted from the primary PC and transmitted back to the Pseudo-mobile PC for use by the user. The Pseudo-mobile PC is not a separate and distinct computing device by itself and has very limited specialized computing power and storage capability compared to the primary PC. With this invention, all the computing power of the CPU, applications, files and services, e.g., high bandwidth internet service, of the primary PC itself are used. Therefore, these resources are not duplicated in the Pseudo-mobile PC. The Pseudo-mobile PC uses as its resources all of the resources of the primary PC.

The invention here disclosed is a new portable electronic mobile device that accesses and uses all the computing power of a primary PC from a remote location. It is a hardware/software embedded system in combination with the primary PC that provides comprehensive mobile computing functions that cannot be fully obtained with currently available devices. The invention here disclosed is a paradigm shift in mobile computing as it does not duplicate, substitute or simply access a primary PC from another computer. Additional advantages obtained are that the Pseudo-mobile PC has an unusually long battery life, is much less expensive and is very light in weight when compared to a laptop or tablet PC. What the invention here disclosed does that is new is to provide a mobile device with all the computing resources that reside within the users primary PC. In this way, nothing within the primary PC needs to be duplicated in the mobile device, except that of installing only once the hardware and software required to allow the mobile device to interface with the primary PC. During operation, no separate ISP charges or software licensing costs are incurred, including MS Windows, MS Office etc., and the only operating cost is the wireless data transmission cost charged by the carrier for actual usage which is similar to cellular telephone costs.

In accordance with the principles of the invention, two embodiments are disclosed. One embodiment is like a cell phone/PDA which is extremely light and small and has only a small touch screen and a detachable keyboard. The keyboard is not required to be carried unless long e-mails or heavy computing is contemplated because the on screen keyboard may not be sufficient. This embodiment automatically includes cell phone functions because any data device is capable of voice, although not the other way around. The second embodiment is like a laptop version which has a bigger high performance monitor, built in keyboard and mouse and all other peripheral connectivity (e.g., printer, fax, USB ports etc.), for high bandwidth usage like heavy computing usage such as composing long documents and graphic presentations. This embodiment is still much less expensive and is smaller and lighter than a traditional laptop, but is perfectly capable of giving the user better flexibility to do all office work (other than being in physical attendance in a meeting) from home, while traveling, or from another office or hotel, than a traditional laptop since the user is operating on his/her primary computer itself.

With this invention remote access is obtained to all applications, all licensed software, and all files, including the Window operating system and ISP service for the internet that reside on the primary PC, and all files continue to be saved and overwritten in the primary PC hard disk. the primary PC continues to use the CPU for processing, updating, networking and internet. The invention disclosed leverages the existing cellular network to provide a simulated primary or Pseudo-mobile PC for the same customized primary PC on a small lightweight handheld device without sacrificing any processing power (CPU) or the advantage of the fixed line high speed internet access (broadband).

While there have been shown and described and pointed out the fundamental features of the invention, it will be understood that various omissions and substitutions and changes of the form and details of the device described and illustrated and in its operation may be made by those skilled in the art, without departing from the spirit of the invention.

What is claimed is:

1. Structure for operating a primary PC from a remotely located Pseudo-mobile PC wherein the primary PC is coupled to a wireless communication channel for transmitting/receiving information signals to/from the Pseudo-mobile PC.

2. Structure for accessing a primary PC from a remotely located Pseudo-mobile PC wherein the primary PC is coupled to a wireless communication channel for transmitting/receiving output information signals to/from the Pseudo-mobile PC.

3. The structure of claims 1 or 2 wherein the wireless communication channel is a telephone cellular network.

4. The structure of claims 1 or 2 wherein the wireless communication channel is a wireless LAN network.

5. The structure of claims 1 or 2 wherein the wireless communication channel is a Wi-Fi connection.

6. The structure of claims 1 or 2 wherein the wireless communication channel is adaptable to another data transmission network.

7. The structure of claim 6 wherein the hardware within the pseudo-mobile PC is adapted to run software having at least four layers wherein:
layer one is adapted to be a translation layer between the Pseudo-mobile PC user interface input signal and the underlying operating system of the desk top PC;
layer two is adapted to digitize and compress the signals for wireless transmission;
layer three is adapted to convert and compress signals and graphic into cellular transmission packets for PSTN network or another network; and
layer four is adapted to transmit the cellular packets over a cellular data transmission network through a router.

8. The apparatus of claims 1 or 2 wherein the pseudo-mobile PC comprises a monitor having a touch sensitive screen.

9. The apparatus of claims 1 or 2 wherein the pseudo-mobile PC comprises a monitor and a keyboard.

10. The apparatus of claim 9 wherein the pseudo-mobile PC comprises a mouse.

11. The apparatus of claims 1 or 2 wherein the pseudo-mobile PC comprises a cell phone/PDA.

12. The apparatus of claim 11 wherein the cell phone/PDA includes a touch screen.

13. The apparatus of claim 12 wherein the cell phone/PDA further includes a detachable keyboard.

14. The apparatus of claims 1 or 2 wherein the pseudo-mobile PC includes a port adapted to be coupled to at least one peripheral.

15. The apparatus of claim 14 wherein the peripheral is a printer.

16. The apparatus of claim 14 wherein the peripheral is a fax.

17. The apparatus of claim 14 wherein the peripheral is an MP3 or other audio player.

18. The apparatus of claim 14 wherein the port is a USB port.

19. A method of accessing and operating a primary PC to process information signals comprising the steps of:
adapting the primary PC to receive and send information signals via a wireless communication channel;
providing a Pseudo-mobile PC coupled to a modem adapted to send and receive information signals via the wireless communication channel to the primary PC wherein the Pseudo-mobile PC relies upon the primary PC to perform the processing of the information signals sent by the Pseudo-mobile PC.

20. The method of claim 19 comprising the further step of adapting the primary PC to send the processed information signals via the wireless communication channel to the Pseudo-mobile PC for use by a user of the Pseudo-mobile PC.

21. The method of claim 20 wherein the information signals sent to the primary PC from the Pseudo-mobile PC are unprocessed signals.

22. The method of claim 21 wherein the unprocessed signals are from a keyboard.

23. The method of claim 21 wherein the unprocessed signals are from a mouse.

24. The method of claim 21 wherein the unprocessed signals are from a touch sensitive screen.

25. The method of claim 20 further comprising the step of displaying the processed signals received from the primary PC on the screen of the Pseudo-mobile PC.
